(19) United States
(12) Patent Application Publication
(10) Pub. No.: US 2026/0192621 A1
(43) Pub. Date: Jul. 9, 2026

(54) FREQUENCY DAMPENING MOUNTING SYSTEM

(71) Applicant: Vibracoustic USA, Inc., Farmington Hills, MI (US)

(72) Inventors: Joshua Edward Cook, Grand Junction, MI (US); Nicholas Daniel Caywood, Kalamazoo, MI (US); Daniel Thomas Harsh, Holland, MI (US)

(21) Appl. No.: 19/015,401

(22) Filed: Jan. 9, 2025

(51) Int. Cl. B60G 11/22

(52) U.S. Cl. CPC B60G 11/22; B60G 2202/143; B60G 2206/42; B60G 2206/73; B60G 2206/81

(57) ABSTRACT

A jounce bumper having a main body with an outer surface and an inner surface extending about a longitudinal central axis between an upper end and a lower end. At least one pocket extends into the outer surface. An annular insert extends into the at least one pocket. The annular insert has an upper surface and a lower surface extending radially between an inner surface bounding a through opening and an outer surface. The outer surface of the annular insert is exposed through the outer surface of the main body.

### FIELD OF THE INVENTION

The present disclosure relates to a frequency dampening mounting system for vehicle systems and assemblies.

### BACKGROUND

Vehicle systems, assemblies and components result in noise and vibration during operation of the vehicle. Efforts to mitigate noise and vibration include frequency dampening and resonant frequency avoidance. The industry utilizes many different types of dampening components and techniques, the selection of which depends on the particular application. Efforts to improve dampening are continuously sought in the industry, as noise and vibration not only lead to more rapid and severe degradation of components, but are also associated with a negative perception of vehicle quality by consumers.

### SUMMARY

A jounce bumper includes a main body having an outer surface and an inner surface extending about a longitudinal central axis between an upper end and a lower end. At least one pocket extends into the outer surface. An annular insert extends into the at least one pocket. The annular insert has an upper surface and a lower surface extending radially between an inner surface bounding a through opening and an outer surface. The outer surface of the annular insert is exposed through the outer surface of the main body.

In accordance with another aspect of the disclosure, a jounce bumper includes annular insert having an upper surface and a lower surface extending radially between an inner surface bounding a through opening and an outer surface. A main body is molded about the annular insert. The main body has an outer surface and an inner surface extending about a longitudinal central axis between an upper end and a lower end. The outer surface of the annular insert is exposed through the outer surface of the main body.

In accordance with another aspect of the disclosure, a method of constructing a jounce bumper is provided. The method includes: providing an annular insert having an upper surface and a lower surface extending radially between an inner surface bounding a through opening and an outer surface; and molding a main body about the annular insert in the mold cavity, the main body having an outer surface and an inner surface extending about a longitudinal central axis between an upper end and a lower end, wherein the outer surface of the annular insert is left exposed through the outer surface of the main body.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of a jounce bumper constructed in accordance with one aspect of the disclosure;

FIG. 2 is a cross-sectional view taken generally along the line 2-2 of FIG. 1;

FIG. 3A is a cross-sectional view taken generally along a central longitudinal axis of the jounce bumper of FIG. 1 illustrating the jounce bumper in a non-compressed state;

FIG. 3B is a view similar to FIG. 3A illustrating the jounce bumper in a compressed state;

FIG. 4 is a view similar to FIG. 1 illustrating a jounce bumper constructed in accordance with another aspect of the disclosure;

FIG. 5 is a cross-sectional view taken generally along the line 5-5 of FIG. 4;

FIG. 6 is a cross-sectional view taken generally along a central longitudinal axis of the jounce bumper of FIG. 4, as viewed along arrow 6-6 of FIG. 5, illustrating the jounce bumper in a non-compressed state;

FIG. 7 is a view similar to FIG. 1 illustrating a jounce bumper constructed in accordance with yet another aspect of the disclosure;

FIG. 8 is a cross-sectional view taken generally along the line 8-8 of FIG. 7; and

FIG. 9 is a cross-sectional view taken generally along a central longitudinal axis of the jounce bumper of FIG. 7 illustrating the jounce bumper in a non-compressed state.

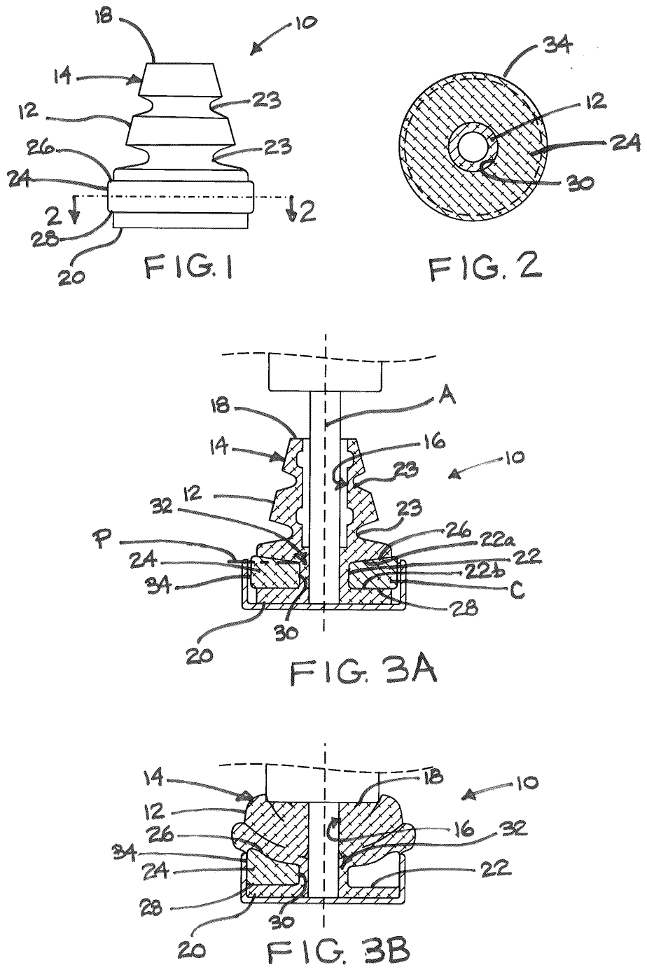

### DETAILED DESCRIPTION

Referring now to the Figures, where the invention will be described with reference to specific embodiments, without limiting same, various embodiments of the invention are illustrated and disclosed herein.

FIG. 1 illustrates a side view of a jounce bumper 10 constructed in accordance with one aspect of the disclosure. Jounce bumper 10 can be disposed in a support pot and cap assembly, as is known, for axial compression and expansion within the support pot along a central longitudinal axis A (FIG. 3A), if desired. Jounce bumper 10 has a main body 12 having an outer surface 14 and an inner surface 16 extending about the longitudinal central axis A between an upper end 18 and an opposite lower end 20. At least one pocket 22 extends into the outer surface. An annular insert 24 is disposed in the at least one pocket 22. The annular insert 24 has an upper surface 26 and a lower surface 28 extending radially, with radially intending to mean relative to and generally transverse to the central longitudinal axis A, between an inner surface 30 bounding a through opening 32 and an outer surface 34. The outer surface 34 is exposed through the outer surface 14 of the main body 12, and in a non-limiting embodiment, extends radially outwardly from the outer surface 14 of the main body 12.

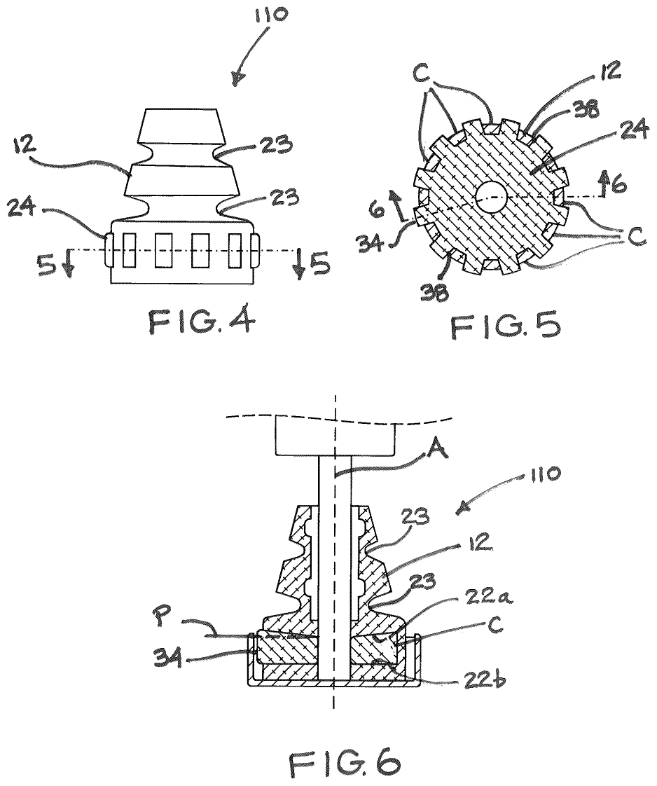

In one non-limiting embodiment, the at least one pocket 22 can be formed as a single annular pocket 22 that extends about the longitudinal central axis A in circumferentially continuous, uninterrupted fashion. As best shown in FIG. 3A, the at least one pocket 22 has an upper pocket surface 22a and a lower pocket surface 22b spaced axially from one another relative to the longitudinal central axis A, wherein at least one column C of material of the main body 12 extends from the upper pocket surface 22a to the lower pocket surface 22b. In another non-limiting embodiment, as shown in FIGS. 4-6, a plurality of columns C of material of the main body 12 extend from the upper pocket surface 22a to the lower pocket surface 22b. The main body 12 can be formed having one or more annular channels 23 recessed into the outer surface 14.

In accordance with a non-limiting aspect of the disclosure, the main body 12 can be formed of a microcellular urethane material (MCU) and the annular insert 24 is an elastomeric thermoplastic polyurethane material (TPU). The MCU can be provided having a density between about 0.5-0.6 g/cm³. The TPU can be provided having a Shore hardness (ShA) between about 80-100 ShA, and in a non-limiting embodiment, about 90 ShA. The material of the annular insert 24 has a greater stiffness than the material of the main body 12.

The annular insert 24 has a cross-sectional area, as viewed in a cross-section taken along the longitudinal central axis A, between about 80 to 95 percent of an area extending radially inward of the outer surface 34 of the annular insert 24, with the upper and lower surfaces 26, 28 delimiting upper and lower boundaries of the area. In a non-limiting embodiment, the upper surface 26 of the annular insert 24 can be formed to extend away from the longitudinal central axis A at an angle between 5 to 15 degrees relative to a plane P (FIGS. 3A and 6) extending in transverse relation to the longitudinal central axis A, and in a more precisely, the upper surface 26 of the annular insert 24 can be formed to extend away from the longitudinal central axis A at an angle between 8 to 12 degrees relative to the plane P. The lower surface 28 of the annular insert 24 can be formed to extend away from the longitudinal central axis A at an angle between 0 to 3 degrees relative to the plane P, thereby being inclined relative to the plane P. Accordingly, the lower surface 28 can be coplanar with the plane P, thereby extending purely transversely from the longitudinal central axis A, or the lower surface 28 can extend away from the plane P in an oblique, inclined relation therefrom up to about 3 degrees relative thereto. When extending away from the plane P in inclined relation, the inclined lower surface 28 diverges away from the plane P from the inner surface 30 toward the outer surface 34, and thus, when viewed looking along the longitudinal central axis A, the lower surface 28 would appear conical, having an annular peak 36 proximate the longitudinal central axis A. The inclined lower surface 28 functions to counter axially directed compressing forces acting on the jounce bumper 10 to self-center the main body 12 relative to the longitudinal central axis A, thereby inhibiting the main body 12 from tilting away from the longitudinal central axis A. Accordingly, uniform compression of the jounce bumper 10 is facilitated by the lower surface 28 being inclined, extending away from the plane P in oblique relation, as discussed above.

At least one of the inner surface 30 and/or the outer surface 34 of the annular insert 24 is cylindrical, and in an exemplary embodiment, both the inner surface 30 and the outer surface 34 of the annular insert 24 is cylindrical. By being cylindrical, the inner and outer surfaces 30, 34 extend in parallel relation from the upper surface 26 to the lower surface 28 in parallel relation with the longitudinal central axis A. The outer surface 34 of the annular insert 24 can be formed to define a maximum outer diameter OD of the jounce bumper 10. Accordingly, the outer surface 34 can extend radially outwardly from the main body 12, such that the entirety of the main body 12 has a maximum outer diameter that is less than the maximum outer diameter OD of the annular insert 24.

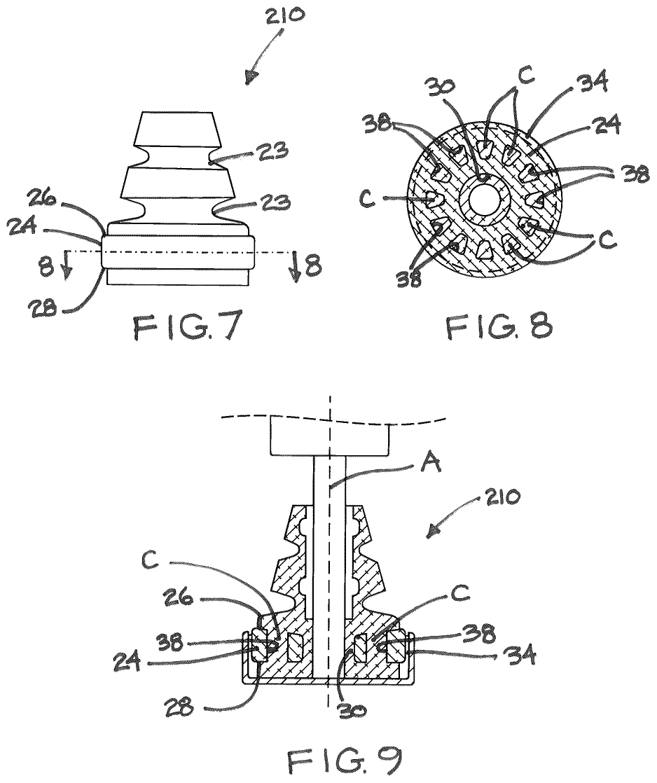

In accordance with another non-limiting embodiment, as shown in FIGS. 7-9, the annular insert 24 can be formed having at least one through passage 38 extending through the upper surface 26 and the lower surface 28 of the annular insert 24, such that the through passage 38 extends entirely through the axially extending extent of the annular insert 24. It is to be recognized that the at least one through passage 38 can include a plurality of through passages 38 spaced from one another, and preferably spaced circumferentially in uniform relation from one another in circumferentially symmetrical relation relative to the longitudinal central axis A. The main body 12 extends through the entirety of at least one through passage 38 to form the at least one column C. In one non-limiting embodiment, the at least one through passage 38 is enclosed between the inner surface 30 and the outer surface 34 of the annular insert 24, such that the through passage 38 forms an enclosed tunnel through the body of the annular insert 24. In another non-limiting embodiment, as shown in FIGS. 4-6, the at least one through passage 38 extends through the outer surface 34 of the annular insert 24. Accordingly, the through passage 24 in this instance forms an exposed (can be seen by viewing the outer surface 34 of the annular insert 24) recessed channel through passage 24 extending radially inwardly into the outer surface 34, as illustrated. It is to be understood that a combination of the aforementioned through passages 38 can be formed in the annular insert 24, such that both exposed and enclosed through passages 38 can be provided in the same annular insert 24. As discussed further hereafter, the at least one through passage 38 facilitates manufacture of the jounce bumper 10 in a molding process, such that the material of the main body 12 can flow through the at least one through passage 38 while molding the main body 12 about the annular insert 24. During the molding process, at least a portion of the upper surface 26, the lower surface 28, and the inner surface 30 of the annular insert 24 are fixedly bonded to the main body 12.

In accordance with another aspect of the disclosure, a method of constructing a jounce bumper 10 is provided. The method includes providing an annular insert 24 having an upper surface 26 and a lower surface 28 extending radially between an inner surface 30 bounding a through opening 32 and an outer surface 34. Further, molding a main body 12 about the annular insert 24 in the mold cavity, the main body 12, upon being molded, having an outer surface 14 and an inner surface 16 extending about a longitudinal central axis A between an upper end 18 and a lower end 20, wherein the outer surface 14 of the annular insert 24 is left exposed through the outer surface 14 of the main body 12.

The method further includes molding the annular insert 24 of a material having a greater stiffness than the main body 12.

The method further includes disposing the annular insert 24 into a mold cavity prior to molding the main body 12 about the annular insert 24.

The method further includes providing the upper surface 26 of the annular insert 24 extending away from the longitudinal central axis A at an angle between 5 to 15 degrees relative to a plane P extending in transverse relation to the longitudinal central axis A.

The method further includes providing the lower surface 28 of the annular insert 24 extending away from the longitudinal central axis A at an angle between 0 to 3 degrees relative to the plane P.

The method further includes causing material of the main body 12 to flow through at least one through passage 38 of the annular insert 24 during the molding process.

Having thus described the invention, it is claimed:

1. A jounce bumper, comprising:
a main body having an outer surface and an inner surface extending about a longitudinal central axis between an upper end and a lower end, at least one pocket extending into the outer surface; and
an annular insert extending into said at least one pocket, the annular insert having an upper surface and a lower surface extending radially between an inner surface bounding a through opening and an outer surface, the outer surface of the annular insert being exposed through the outer surface of the main body.

2. The jounce bumper of claim 1, wherein the outer surface of the annular insert extends radially outwardly from the outer surface of the main body.

3. The jounce bumper of claim 1, wherein the annular insert has a cross-sectional area, as viewed in a cross-section taken along the longitudinal central axis, between about 80 to 95 percent of an area extending radially inward of the outer surface of the annular insert.

4. The jounce bumper of claim 1, wherein the upper surface of the annular insert extends away from the longitudinal central axis at an angle between 5 to 15 degrees relative to a plane extending in transverse relation to the longitudinal central axis.

5. The jounce bumper of claim 4, wherein the upper surface of the annular insert extends away from the longitudinal central axis at an angle between 8 to 12 degrees relative to the plane.

6. The jounce bumper of claim 4, wherein the lower surface of the annular insert extends away from the longitudinal central axis at an angle between 0 to 3 degrees relative to the plane.

7. The jounce bumper of claim 6, wherein at least one of the inner surface and the outer surface of the annular insert is cylindrical.

8. The jounce bumper of claim 1, wherein the outer surface of the annular insert defines a maximum outer diameter of the jounce bumper.

9. The jounce bumper of claim 1, further including at least one through passage extending through the upper surface and the lower surface of the annular insert, wherein the main body extends through the at least one through passage.

10. The jounce bumper of claim 9, wherein the at least one through passage extends through the outer surface of the annular insert.

11. The jounce bumper of claim 9, wherein the at least one through passage is enclosed between the inner surface and the outer surface of the annular insert.

12. The jounce bumper of claim 1, wherein at least a portion of the upper surface, the lower surface and the inner surface of the annular insert are bonded to the main body.

13. The jounce bumper of claim 1, wherein the main body is a microcellular urethane material and the annular insert is a thermoplastic polyurethane material.

14. The jounce bumper of claim 1, wherein the at least one pocket is a single annular pocket that extends about the longitudinal central axis in circumferentially continuous, uninterrupted fashion.

15. The jounce bumper of claim 1, wherein the at least one pocket has an upper pocket surface and a lower pocket surface spaced axially from one another relative to the longitudinal central axis, wherein at least one column of material of the main body extends from the upper pocket surface to the lower pocket surface.

16. The jounce bumper of claim 15, wherein a plurality of columns of material of the main body extend from the upper pocket surface to the lower pocket surface.

17. A jounce bumper, comprising:
an annular insert having an upper surface and a lower surface extending radially between an inner surface bounding a through opening and an outer surface; and
a main body molded about the annular insert, the main body having an outer surface and an inner surface extending about a longitudinal central axis between an upper end and a lower end,
wherein the outer surface of the annular insert is exposed through the outer surface of the main body.

18. The jounce bumper of claim 17, wherein the outer surface of the annular insert extends radially outwardly from the outer surface of the main body.

19. The jounce bumper of claim 17, wherein the annular insert is a solid toroid.

20. The jounce bumper of claim 17, wherein the upper surface of the annular insert extends away from the longitudinal central axis at an angle between 5 to 15 degrees relative to a plane extending in transverse relation to the longitudinal central axis.

21. The jounce bumper of claim 17, wherein the annular insert is molded of a material having a greater stiffness than the main body.

22. A method of constructing a jounce bumper, comprising:
providing an annular insert having an upper surface and a lower surface extending radially between an inner surface bounding a through opening and an outer surface; and
molding a main body about the annular insert in the mold cavity, the main body having an outer surface and an inner surface extending about a longitudinal central axis between an upper end and a lower end, wherein the outer surface of the annular insert is left exposed through the outer surface of the main body.

23. The method of claim 22, wherein the providing includes molding the annular insert of a material having a greater stiffness than the main body.

24. The method of claim 23, further including disposing the annular insert into a mold cavity prior to molding the main body about the annular insert.

25. The method of claim 21, further including providing the upper surface of the annular insert extending away from the longitudinal central axis at an angle between 5 to 15 degrees relative to a plane extending in transverse relation to the longitudinal central axis.

26. The method of claim 25, further including providing the lower surface of the annular insert extending away from the longitudinal central axis at an angle between 0 to 3 degrees relative to the plane.
